(19) United States
(12) Patent Application Publication
(10) Pub. No.: US 2018/0351150 A1
(43) Pub. Date: Dec. 6, 2018

(54) PACKAGING SYSTEMS AND METHODS FOR BATTERIES

(71) Applicant: Alpha Technologies Inc., Bellingham, WA (US)

(72) Inventors: Craig Paoli, Lynden, WA (US); Matthew Regan, Bellingham, WA (US); Brian Overhauser, Ferndale, WA (US); Thomas P. Newberry, Blaine, WA (US)

(21) Appl. No.: 15/965,684

(22) Filed: Apr. 27, 2018

Related U.S. Application Data
(60) Provisional application No. 62/492,039, filed on Apr. 28, 2017.

(51) Int. Cl. H01M 2/20; H01M 2/30; H01M 2/10; H01M 2/02

(52) U.S. Cl. CPC H01M 2/202; H01M 2/0257; H01M 2/1016; H01M 2/30

(57) ABSTRACT

A battery block comprises first and second batteries each defining at least one vent port, a first terminal assembly connected to a positive terminal of the first battery, a second terminal assembly connected to a positive terminal of the second battery, at least one connector assembly connected to a negative terminal of the first battery and to a positive terminal of the second battery, and a matrix of rigid material. The matrix of rigid material surrounds at least a portion of the first and second batteries to secure the first and second batteries together, covers the at least one connector assembly to inhibit removal of the at least one connector assembly from the negative terminal of the first battery and the positive terminal of the second battery, and defines a void over at least a portion of the at least one vent port in the first and second batteries.

### RELATED APPLICATIONS

This application (Attorney's Ref. No. P219459) claims benefit of U.S. Provisional Patent Application Ser. No. 62/492,039 filed Apr. 28, 2017, currently pending.

The contents of the related application listed above are incorporated herein by reference.

### TECHNICAL FIELD

The present invention generally relates to battery systems and methods and, more specifically, to systems and methods for packaging batteries for use in remote locations.

### BACKGROUND

Battery systems are often deployed at remote and/or unattended locations. For example, communications systems often employ uninterruptible power supplies strategically located through the communications system to provide power when utility power is unavailable or outside of predetermined parameters.

Uninterruptible power supplies for communications systems are typically configured to operate at 60 VAC or 90 VAC from battery systems configured to generate 36 VDC or 48 VDC. Given the energy requirements of communications systems, lead-acid batteries are typically used in uninterruptible power supplies for communications systems. Because most mass produced lead-acid batteries operate at 12 VDC, uninterruptible power supplies for communications systems typically comprise strings of 12 VDC lead-acid batteries to take advantage of the economies of scale inherent in the mass production of lead-acid batteries that operate at 12 VDC.

Battery systems deployed at remote locations are often left unattended for long periods of time. The batteries of unattended battery systems may easily be stolen and repurposed, especially if the remote battery system is formed of a plurality of individual 12 VDC lead-acid batteries. Individual 12 VDC lead-acid batteries may easily be repurposed for use with common loads such as vehicle electronics. The theft of discrete batteries from uninterruptible power supply sites providing backup power for communication systems poses significant problems.

The need thus exists for packaging systems and methods for batteries that reduce theft of battery systems installed at remote or unattended locations.

### SUMMARY

The present invention may be embodied as a battery block comprising at least first and second batteries, first and second terminal assemblies, at least one connector assembly, and a matrix of rigid material. The first and second batteries each define at least one vent port. The first terminal assembly is connected to a positive terminal of the first battery. The second terminal assembly is connected to a positive terminal of the second battery. The at least one connector assembly is arranged to electrically connect a negative terminal of the first battery to a positive terminal of the second battery. The matrix of rigid material surrounds at least a portion of the first and second batteries to secure the first and second batteries together, covers the at least one connector assembly to inhibit removal of the at least one connector assembly from the negative terminal of the first battery and the positive terminal of the second battery, and defines a void over at least a portion of the at least one vent port in the first and second batteries.

The present invention may also be embodied as a battery system comprising a plurality of battery blocks. Each battery block comprises at least first and second batteries each defining at least one vent port, a first terminal assembly connected to a positive terminal of the first battery, a second terminal assembly connected to a positive terminal of the second battery, at least one connector assembly arranged to electrically connect a negative terminal of the first battery to a positive terminal of the second battery, and a matrix of rigid material. The matrix of rigid material surrounds at least a portion of the first and second batteries to secure the first and second batteries together, covers the at least one connector assembly to inhibit removal of the at least one connector assembly from the negative terminal of the first battery and the positive terminal of the second battery, and defines a void over at least a portion of the at least one vent port in the first and second batteries. At least a portion of the first and second terminal assemblies of each of the plurality of battery blocks is not covered by the matrix to allow the plurality of battery blocks to be electrically connected.

The present invention may also be embodied as a method of forming a battery block comprising the following steps. At least first and second batteries each defining at least one vent port are provided. A first terminal assembly is operatively connected to a positive terminal of the first battery. A second terminal assembly is operatively connected to a positive terminal of the second battery. At least one connector assembly is arranged to electrically connect a negative terminal of the first battery to a positive terminal of the second battery. A matrix of rigid material is formed by arranging block material such that the block material surrounds at least a portion of the first and second batteries, covers the at least one connector assembly, and defines a void over at least a portion of the at least one vent port in the first and second batteries. The block material is allowed solidify to form the matrix of rigid material such that the first and second batteries are secured together and removal of the at least one connector assembly from the negative terminal of the first battery and the positive terminal of the second battery is inhibited.

### BRIEF DESCRIPTION OF THE DRAWINGS

FIG. 1 is a top plan view of a plurality of first example battery blocks of the present invention as supported for use as part of a battery system;

FIG. 2 is a front elevation view of one of the plurality of first example battery blocks of the present invention as supported for use as part of a battery system;

FIG. 3 is a front elevation partially exploded view of a battery string assembly formed during a first example process of forming the first example battery block;

FIG. 4 is a top plan view of the battery string assembly;

FIG. 5 is a side elevation view of the battery string assembly;

FIG. 6 is a top plan view of the battery string assembly arranged within a mold structure;

FIG. 7 is a front elevation section view taken along lines 7-7 in FIG. 6 of the battery string assembly arranged within the mold structure;

FIG. 8 is a side elevation section view taken along lines 8-8 in FIG. 6 of the battery string assembly arranged within the mold structure and with a tape assembly arranged at a predetermined position on the battery string assembly;

FIG. 9 is an enlarged view of a portion of FIG. 8 depicting the tape assembly in a pre-mold configuration;

FIG. 10 is a top plan view of the battery string assembly arranged within the mold structure and with a tape assembly in the pre-mold configuration and a matrix of block material arranged within the mold structure;

FIG. 11 is section view taken along lines 11-11 in FIG. 10;

FIG. 12 is section view taken along lines 12-12 in FIG. 10;

FIG. 13 is an enlarged view of a portion of FIG. 12 depicting the tape assembly in the pre-mold configuration within the matrix of block material;

FIG. 14 is an enlarged view similar to FIG. 13 depicting the tape assembly being reconfigured from the pre-mold configuration to a release configuration;

FIG. 15 is an enlarged view similar to FIG. 13 depicting the tape assembly in the release configuration;

FIG. 16 is an enlarged view similar to FIG. 13 depicting the first example battery block with the tape assembly removed;

FIG. 17 is a top plan view of the first example battery block;

FIG. 18 is a top plan view depicting a step of a second example process of forming the first example battery block;

FIG. 19 is a section view taken along lines 19-19 in FIG. 18;

FIG. 20 is a section view similar to FIG. 19 showing another step of the second example process of forming the first example battery block;

FIG. 21 is a section view similar to FIG. 19 showing the first example battery block after a final step of the second example process of forming the first example battery block;

FIG. 22 is a top plan view of a second example battery block; and

FIG. 23 is a front elevation view of one of a plurality of third example battery blocks of the present invention as supported for use as part of a battery system.

### DETAILED DESCRIPTION

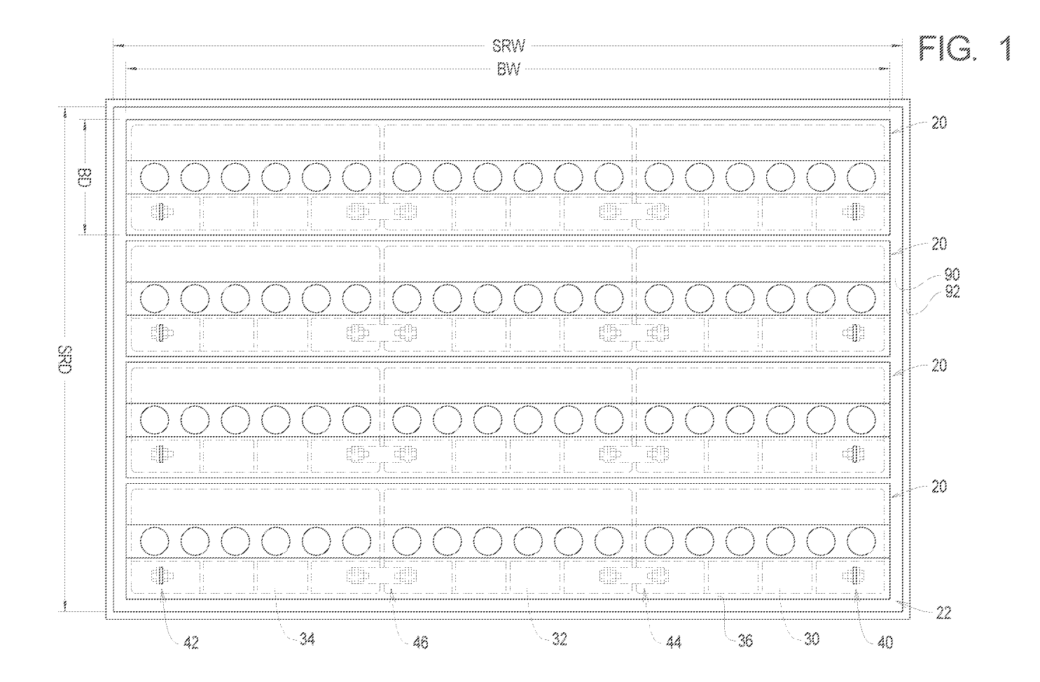

Referring initially to FIG. 1 of the drawing, depicted therein is a plurality of first example battery blocks 20 arranged to define a first example battery array 22 of the present invention. Each of the first example battery blocks 20 comprises a plurality (i.e., two or more) of batteries connected in series such that a block voltage of the first example battery block 20 is different than the battery voltages of any one of the plurality of batteries forming the first example battery block 20. Each of the plurality of batteries forming the first example battery blocks 20 is further physically bonded to at least one other of the plurality of batteries to inhibit use of any one or more of the plurality of batteries except at the block voltage defined by the plurality of series connected individual batteries. The first example battery blocks 20 thus may be effectively only easily used at the block voltage and may not be easily used at the individual battery voltages.

More specifically, the first example battery blocks 20 each comprises first, second, and third batteries 30, 32, and 34 arranged within a matrix 36 of block material. The matrix 36 physically bonds the first, second, and third batteries to each other. And as will be described in further detail below, the matrix 36 is further configured to engage the batteries 30, 32, and 34 such that certain components of the batteries 30, 32, and 34 are substantially inaccessible while other components of the batteries 30, 32, and 34 are substantially unobstructed.

The first example battery blocks 20 each further comprise first and second terminal assemblies 40 and 42 and first and second connector assemblies 44 and 46. The first connector assembly 44 is connected to the first and second batteries 30 and 32 and the second connector assembly is connected between the second and third batteries 32 and 34 such that the first, second, and third batteries 30, 32, and 34 are connected in series. The first and second terminal assemblies 40 and 42 are connected to the first and third batteries 30 and 34 such that the series voltage defined by the series connected first, second, and third batteries 30, 32, and 34 is present across the first and second end terminal assemblies 40 and 42.

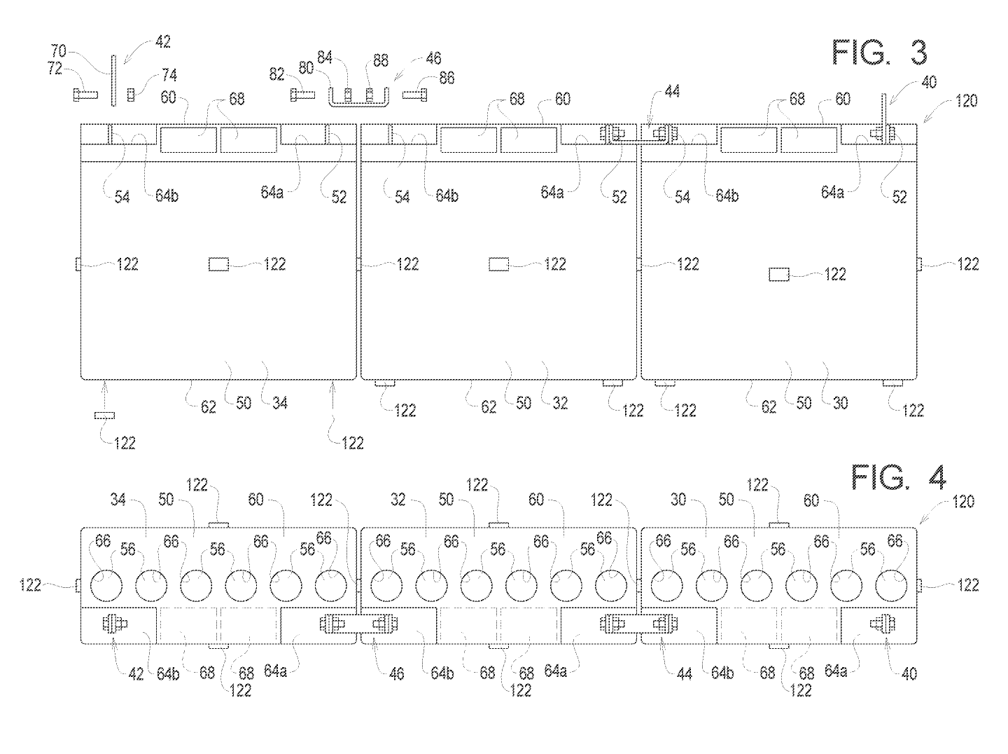

Referring now to FIGS. 3 and 4, the details of the example first battery 30, second battery 32, and third battery 34 will now be described in further detail. Although not necessarily the same, the example first, second, and third batteries 30, 32, and 34 are identical. Accordingly, the same reference characters will be used to refer to similar components of the example first, second, and third batteries 30, 32, and 34.

The example batteries 30, 32, and 34 are or may be conventional batteries each comprising a housing assembly 50 supporting a positive terminal 52, a negative terminal 54, and at least one vent cover 56 (FIG. 4). The example housing assembly 50 defines a first wall surface 60, a second wall surface 62, and first and second terminal surfaces 64a and 64b. The example housing assemblies 50 further define at least one vent opening 66 and at least one recess 68. The example first and second wall surfaces 60 and 62 are substantially parallel to each other. The example terminal surfaces 64a and 64b are substantially parallel to and arranged between the first and second wall surfaces 60 and 62 such that the terminal surfaces 64a and 64b are offset from the first wall surface 60. In the example housing assembly 50, six of the example vent openings 66 are formed in the first wall 60, and one vent cover 56 is arranged to cover each of the vent openings 66.

The example first and second terminal assemblies 40 and 42 and example first and second connector assemblies will now be described in further detail with reference to FIGS. 3 and 4.

Although not necessarily the same, the example first and second terminal assemblies 40 and 42 are identical. Accordingly, the same reference characters will be used to refer to similar components of the example first and second terminal assemblies 40 and 42. As perhaps best shown in FIG. 3, the example terminal assemblies 40 and 42 each comprise a terminal plate 70, a terminal bolt 72, and a terminal nut 74. One terminal plate 70 is arranged in a desired orientation relative to each of the positive terminal 52 of the first battery 30 and the negative terminal 54 of the third battery 34. A terminal bolt 72 is inserted through openings (not visible) in the plate 70 and the positive terminal 52 of the first battery 30. A terminal bolt 72 is inserted through openings (not visible) in the plate 70 and the negative terminal 54 of the third battery 34. The terminal nuts 74 are threaded onto the terminal bolts 72 to secure the terminal plates 70 to the positive terminal 52 of the first battery 30 and the negative terminal 54 of the third battery 34 as perhaps best shown in FIG. 4.

The example connecting assemblies 44 and 46 are also not necessarily the same but are identical in the first example battery block 20. Accordingly, the same reference characters will be used to refer to similar components of the example first and second connecting assemblies 44 and 46. As perhaps best shown in FIG. 3, the example connecting assemblies 44 and 46 each comprise a connecting plate 80, a first connecting terminal bolt 82, a first connecting nut 84, a second connecting terminal bolt 86, and a second connecting nut 88. A connecting plate 80 is arranged in a desired orientation relative to the negative terminal 54 of the first battery 30 and the positive terminal 52 of the second battery 32. First and second connecting bolts 82 and 86 are inserted through openings (not visible) in the connecting plate 80 and the negative terminal 54 of the first battery 30 and the positive terminal 52 of the second battery 32. Connecting nuts 84 and 88 are threaded onto the first and second connecting terminal bolts 82 and 86 to secure the connecting plate 80 to the negative terminal 54 of the first battery 30 and the positive terminal 52 of the second battery 32. A connecting plate 80 is similarly arranged in a desired orientation relative to the negative terminal 54 of the second battery 32 and the positive terminal 52 of the third battery 34. First and second connecting bolts 82 and 86 are inserted through openings (not visible) in the connecting plate 80 and the negative terminal 54 of the second battery 32 and the positive terminal 52 of the third battery 34. Connecting nuts 84 and 88 are threaded onto the first and second connecting bolts to secure the connecting plate 80 to the negative terminal 54 of the second battery 32 and the positive terminal 52 of the third battery 34.

At this point, the first, second, and third batteries 30, 32, and 34 are electrically connected in series. Further, the terminal plate 70 of the first terminal assembly 40 is electrically connected to the positive terminal 52 of the first battery 30, and the terminal plate 70 of the second terminal assembly 40 is electrically connected to the negative terminal 54 of the third battery 34. The voltage across the first terminal assembly 40 and the second terminal assembly 42 is thus the sum of the voltages across the first, second, and third batteries 30, 32, and 34 connected in series.

The individual first example battery blocks 20 forming the battery array 22 are connected in parallel to increase the energy storage capacitor of the battery array. Further, the first example battery array 22 is configured such that the first example battery blocks 20 form part of an electronics system (not shown) such as an uninterruptible power supply. The first example battery blocks 20 used by the first example battery array 22 are identical, and the first example battery array 22 consists of four of the first example battery blocks 20 electrically connected in parallel as will be described in further detail below. However, a battery array employing one or more of first example battery blocks 20 may comprise additional batteries of one or more different form factors so long as the additional batteries are electrically compatible with the first example battery blocks 20.

In the example battery block 20, the example first, second, and third batteries 30, 32, and 34 forming the first example battery block 20 are 12 VDC batteries. Accordingly, the voltage across the first terminal assembly 40 and the second terminal assembly 42 is 36 VDC. With the first example battery blocks 20 connected in parallel to form the battery array 22, the voltage across the battery array 22 is also 36 VDC.

The first example battery blocks 20 of the first example battery array 22 are configured to be supported within a support region 90 defined by a support structure 92. The support region 90 and support structure 92 do not form part of the present invention and are relevant to a discussion of the first example battery blocks 20 only in that a form factor of the first example battery blocks 20 and physical dimensions of the support region 90 are compatible. The form factor of the first example battery blocks 20 is such that four of the first example battery blocks 20 may be arranged within the example support region 90. The example support structure 92 is a shelf movably supported by a cabinet (not shown) to facilitate access to the support region 90, but other support structures may be used in addition or instead.

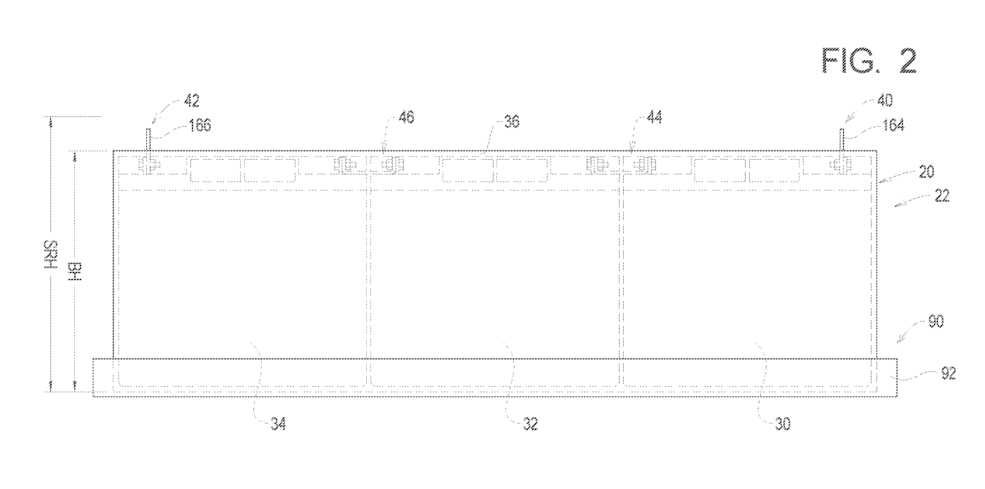

In particular, as shown in FIGS. 1 and 2 the first example battery blocks 20 each define a battery width BW, a battery depth BD, and a battery height BH. The example support region 90 defines a support region width SRW, a support region depth SRD, and a support region height SRH. The battery width BW of the each of first example battery blocks 20 is slightly less than the support region width SRW of the example support region 90, and the battery depth BD of each of the first example battery blocks 20 is slightly less than one quarter of the support region depth SRD of the example support region 90. Accordingly, four of the first example battery blocks 20 may be arranged within the surface area defined by the support region 90 as depicted in FIG. 1. In addition, the battery height BH is less than the support region height SRH by an amount sufficient to allow cables (not shown) to be run as necessary to connect the first example battery blocks 20 together to form the battery array 22 and to connect the battery array 22 to an electronics system (not shown) such as an uninterruptible power supply.

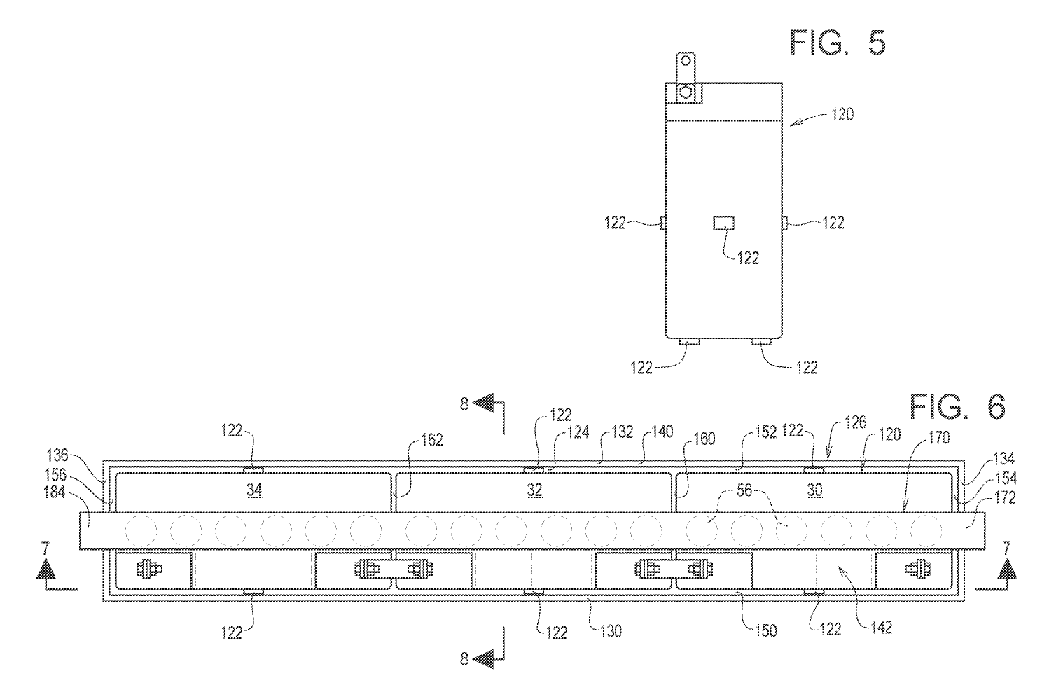

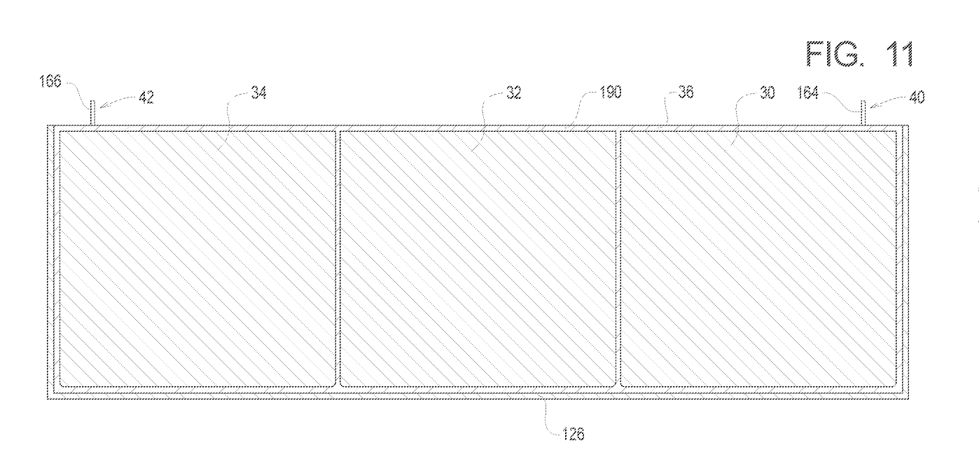

Turning now to FIGS. 3-17 of the drawing, a first example method of forming the a battery block of the present invention, such as the first example battery block 20, will now be described.

FIG. 3 illustrates that the first, second, and third batteries 30, 32, and 34 are assembled into a battery assembly 120 using the first and second terminal assemblies 40 and 42 and the first and second connector assemblies 44 and 46. In the first example method, optional spacers 122 are attached to each of the batteries 30, 32, and 34 of the battery assembly 120 to as shown in FIGS. 3-8.

The battery assembly 120 is arranged within a mold cavity 124 defined by a mold structure 126 as shown in FIG. 6. The battery assembly 120 may optionally formed with the first, second, and third batteries 30, 32, and 34 first arranged within the mold cavity 124.

In particular, FIGS. 6-8 illustrate that the example mold structure 126 comprises first and second side walls 130 and 132, first and second end walls 134 and 136, and a bottom wall 138. The mold structure 126 further defines an upper edge 140 extending around the first and second side walls 130 and 132 and the first and second end walls 134 and 136. The example upper edge 140 is substantially parallel to the bottom wall 138 and defines a mold opening 142. The mold structure 126 is sized and dimensioned relative to the battery assembly 120 to define an upper region 144 of the mold cavity 124 as will be described in further detail below.

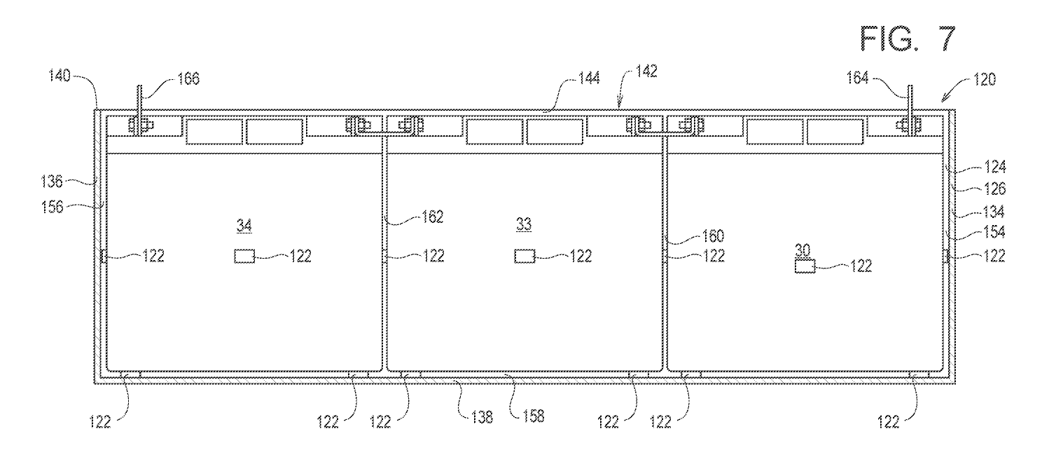

The battery assembly 120 is centered within the mold structure 126 to define first and second side gaps 150 and 152, first and second end gaps 154 and 156, and a bottom gap 158 adjacent to the first and second side walls 130 and 132, the first and second end walls 134 and 136, and the bottom wall 138 of the mold structure 126, respectively. And as shown in FIGS. 6 and 7, a first intermediate gap 160 is formed between the first and second batteries 30 and 32, and a second intermediate gap 162 is formed between the second and third batteries 32 and 34.

FIGS. 3-8 illustrate that one or more of the spacers 122 may be arranged on the side walls of the batteries 30, 32, and 34 to define the side gaps 150 and 152, on the exposed outer end walls of the end batteries 30 and 34 to define the end gaps 154 and 156, on the inner end walls of a first pair of adjacent batteries 30 and 32 to define the first intermediate gap 160, and/or on the inner end walls of a second pair of adjacent batteries 32 and 34 to define the second intermediate gap 162.

The battery assembly 120 is substantially centered within the mold cavity 124 such that the volume of the first side gap 150 is substantially the same as the volume of the second side gap 152 and the volume of the first end gap 154 is substantially the same as the second end gap 156. The volume of the bottom gap 158 is defined by the spacers 122. The volume of the first and second intermediate gaps 160 and 162 is determined by dimensions of the connector plates 80.

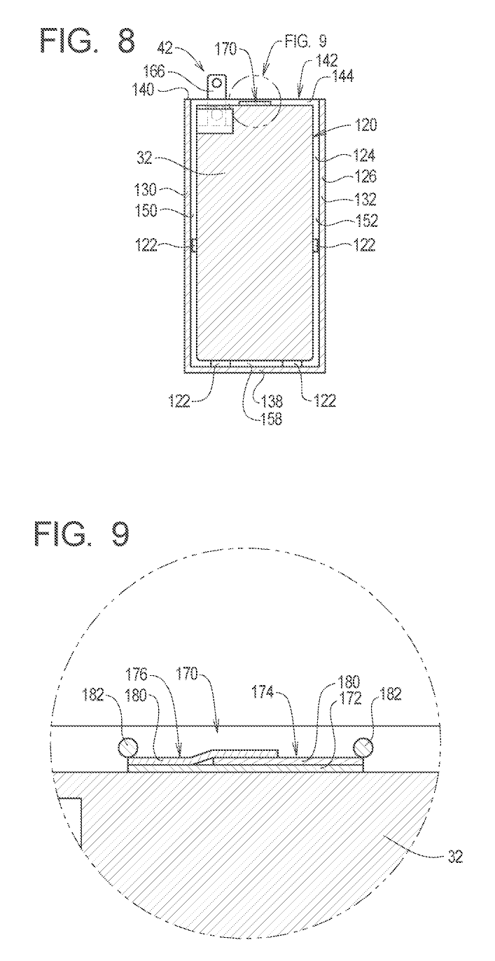

As shown in FIGS. 7 and 8, when the battery assembly 120 is within the mold cavity 124, the upper region 144 of the mold cavity 124 is located above the entire battery assembly 120 except for exposed portions 164 and 166 of the terminal plates 70 of the first and second terminal assemblies 40 and 42. In particular, the first and second terminal surfaces 64a and 64b are arranged such that the positive and negative terminals 52 and 54 are entirely below the first wall surfaces 60. Further, the connector plates 80 are configured such that the first and second connector assemblies 44 and 46 are also entirely below the first wall surfaces 60. Only the exposed portions 164 and 166 of the first and second terminal assemblies 40 and 42 extend out of the mold cavity 124. Accordingly, the first wall surfaces 60 of the batteries 30, 32, and 34 and the first and second connector assemblies 44 and 46 are spaced below the upper edge 140 of the mold structure 126 prior to formation of the matrix 36.

With the battery assembly 120 so arranged within the mold cavity 124, a tape assembly 170 is detachably attached to the batteries 30, 32, and 34 to cover the vent openings 66 (and vent covers 56 covering the vent openings 66) as shown in FIGS. 6 and 8. FIG. 9 illustrates that the example tape assembly 170 comprises a primary tape member 172 and first and second cord tape members 174 and 176. Each cord tape member comprises a tape portion 180 and a cord portion 182. At least one end 184 of the tape assembly 170 is arranged such that at least one end of at least the primary tape member 172 and at least one end of the cord portions 182 of the first and second cord tape members 174 and 176 are arranged outside of the mold cavity 124.

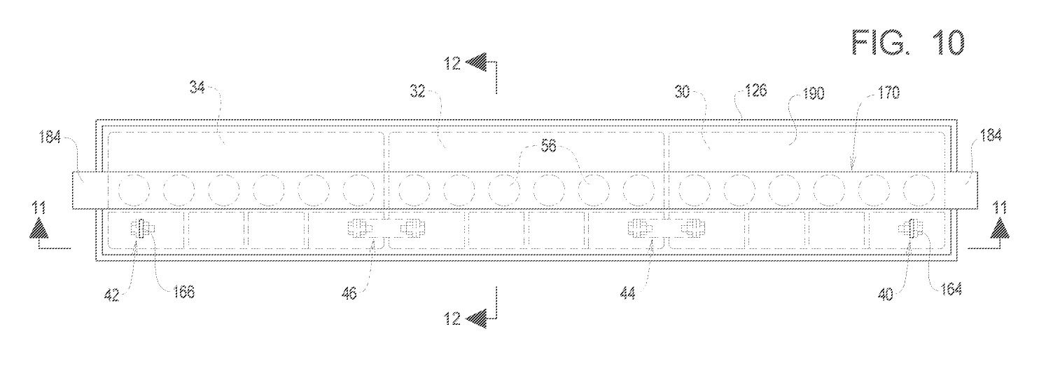

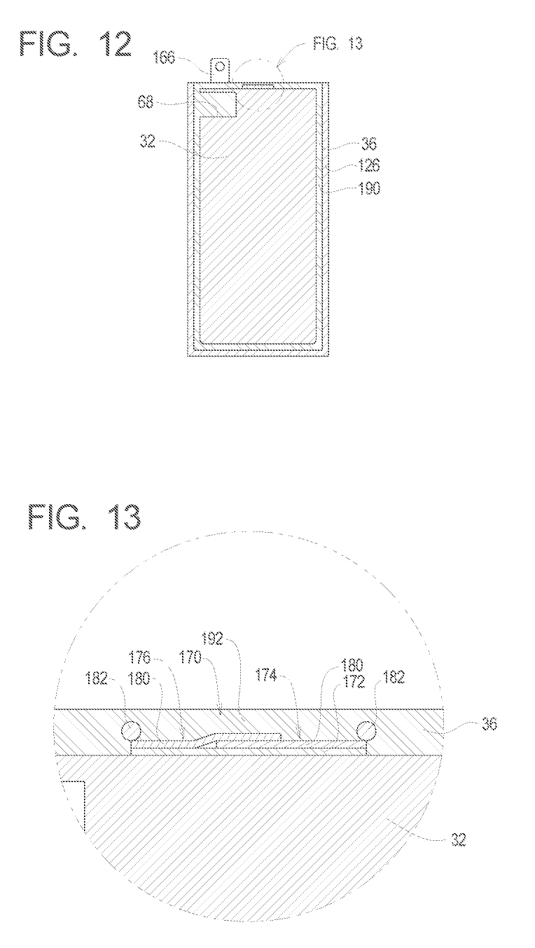

As shown in FIGS. 10-12, block material 190 in flowable form is introduced into the mold cavity 124 through the mold opening 142 and allowed to flow into the first and second side gaps 150 and 152, first and second end gaps 154 and 156, bottom gap 158, and first and second intermediate gaps 160 and 162. After the gaps 150, 152, 154, 156, 158, 160, and 162 are filled, additional block material 190 in flowable form is introduced in mold cavity 124 to fill the upper region 144 and thus cover the entire battery assembly 120 and the tape assembly 170 except for the exposed portions 164 and 166 of the first and second terminal assemblies 40 and 42 and the ends 184 of the tape assembly 170. FIG. 12 illustrates that the block material 190 in flowable form will also flow into the recesses 68 defined by the example batteries 30, 32, and 34. The spacers 122 are made of a material compatible with the block material 190.

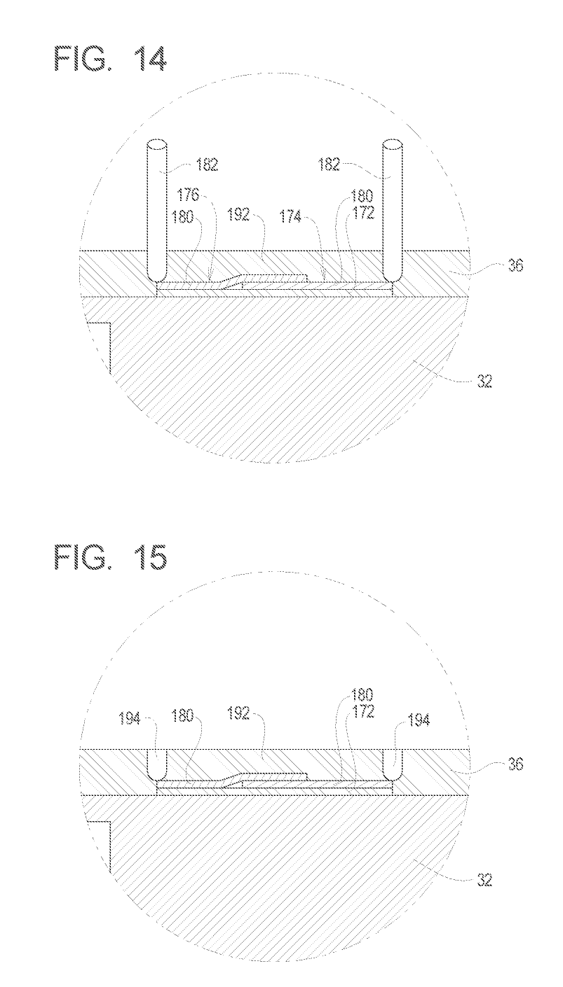

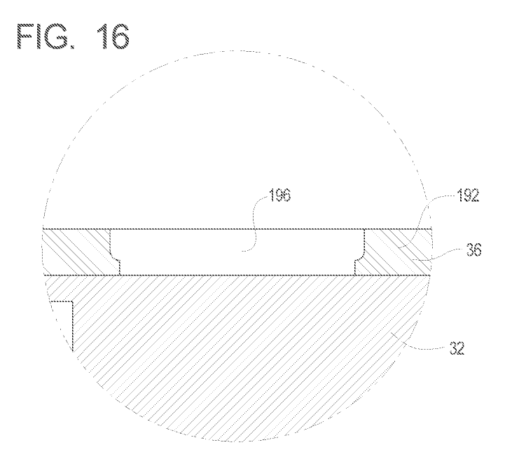

The block material 190 is allowed to partially solidify such that it is no longer flowable but is only partially rigid; block material in non-flowable, non-rigid form is depicted at 192 in FIGS. 13 and 14. Free ends of the cords 182 of the first and second cord tapes 174 and 176 are then pulled as shown in FIG. 14 to expose edges 194 of the cord tape portions 180 of the first and second cord tapes 174 and 176 as shown in FIG. 15. Then, one or both of the exposed ends of the primary tape 172 are pulled to remove the remnants of the tape assembly 170 and the non-flowable, non-rigid block material 192 to create a void 196 above the tape assembly 170 as shown in FIG. 16.

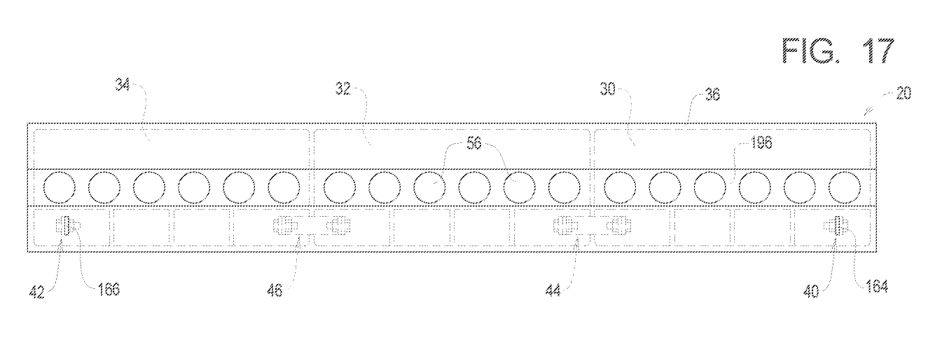

At this point, the vent openings 66 as covered by the vent covers 56 are exposed (not covered by potting compound in an airtight manner) to allow gasses within the batteries 30, 32, and 34 to be vented from the vent openings 66 in a conventional manner. The non-flowable, non-rigid form block material 192 is then allowed to fully cure to obtain the rigid matrix 36 as shown in FIG. 17.

As the block material 190 sets in the non-flowable, non-rigid form and forms the rigid matrix 36, one or more of the spacers 122 is replaced by the block material 190 (e.g., dissolved such that volume of the spacers 122 is filled by the block material 190/192), or the spacers 122 may be incorporated into the non-flowable, rigid block material 192. The rigid matrix 36 thus comprises one or both of the block material 190/192 and the spacers 122 such that the batteries 30, 32, and 34 are entirely protected by the rigid matrix 36.

The example block material forming the matrix 36 may be any material capable of flowing around the battery assembly 120 within the mold cavity 124 as described herein and then solidifying to encapsulate the batteries 30, 32, and 34, portions of connector assemblies 40 and 42, and the connector assemblies 44 and 46 as described herein. The block material may chemically bond to or fuse with the material forming the battery housing assembly 50 and/or the spacers 122 such that the matrix 36 formed thereby is a solid member that encapsulates batteries 30, 32, and 34 to inhibit separation of the batteries 30, 32, and 34 into separate operable units, access to the terminals 52 and 54 thereof, and/or use of the first example battery block 20 at any voltage other than the block voltage.

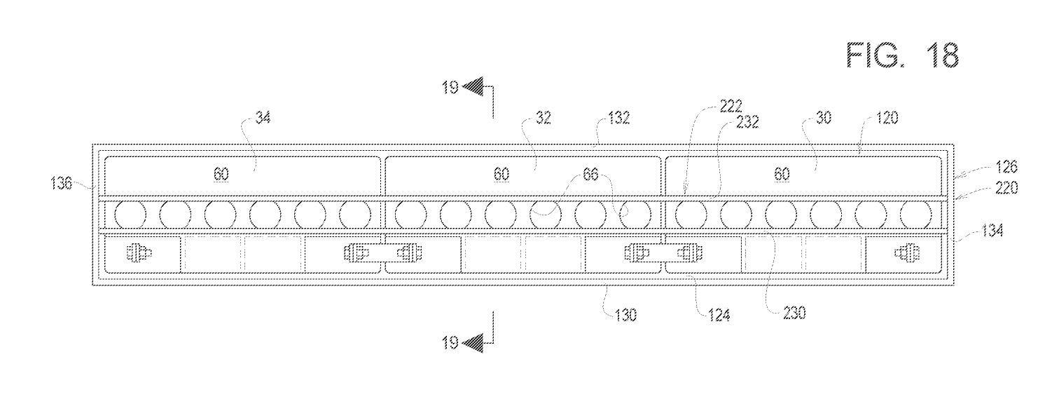

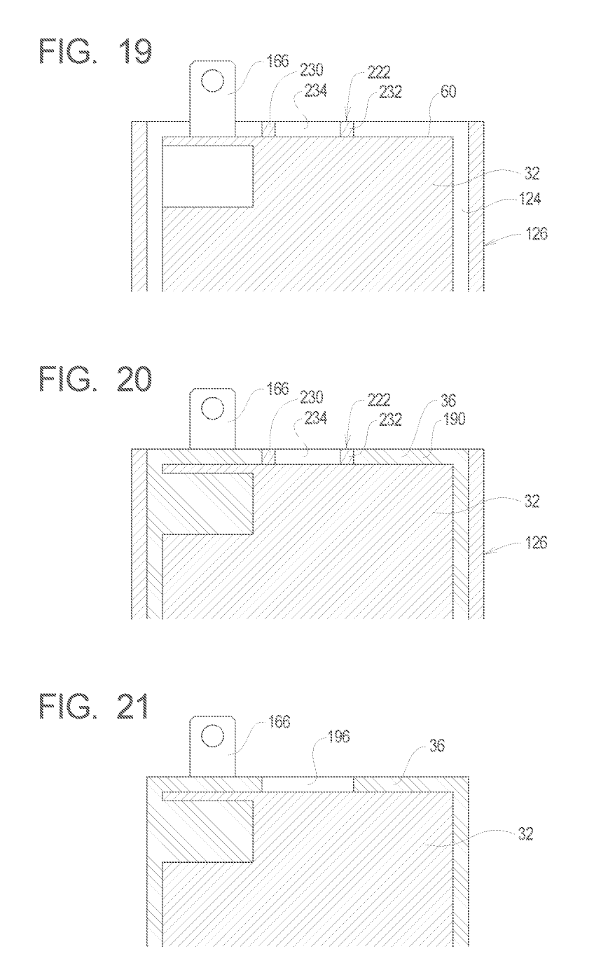

The first example battery block 20 may be formed using a second example method as depicted in FIGS. 18-21. The second example method is similar to the first example method but may be used without at least some components of the tape assembly 170. As shown in FIGS. 18-20, using the second example method, the battery assembly 120 is arranged within a mold assembly 220 comprising the mold structure 126 and a dam structure 222.

The example dam structure 222 comprises at least first and second dam members 230 and 232 that each extend between the first and second end walls 134 and 136 of the mold structure 126. With the battery assembly 120 arranged within the mold structure 126 as generally described above, the dam structure 222 is arranged such that the dam members 230 and 232 extend along edges of the vent openings 66 as shown in FIG. 18. The dam members 230 and 232 thus engage the first wall surface 60 to define a dam void 234 above the vent openings 66. Pressure by clamp or weight may be applied to the dam members 230 and 232 to hold them against the first wall surfaces 60 of the batteries 30, 32, and 34 to assist with the formation of a substantially fluid-tight seal between the dam members 230 and 232 and the first wall surface 60.

The flowable potting or block material 190 is then introduced into the mold cavity 124 and allowed to flow up against the dam members 230 and 232 as shown in FIG. 20. When the block or potting material 190 is in its non-rigid, non-flowable form 192, the dam structure 222 is removed, leaving the void 196 above the vent openings 66.

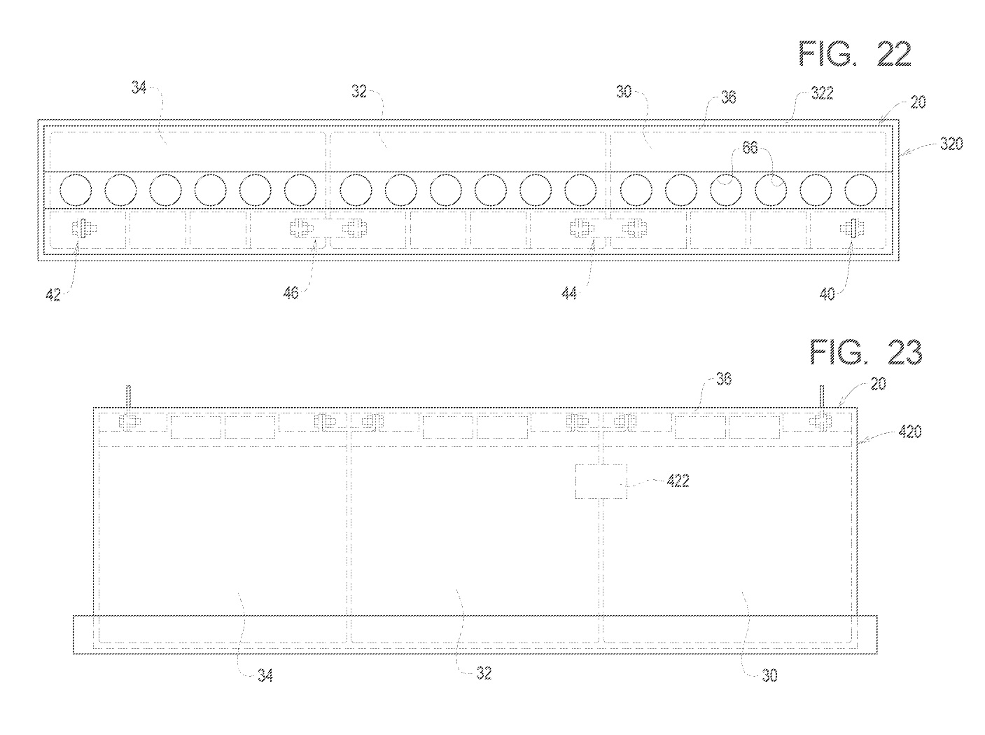

FIG. 22 illustrates a second example battery block 320 constructed in accordance with, and embodying, the principles of the present invention. The second example battery block 320 is formed by the combination of the first example battery block 20 as described above with a jacket structure 322. The jacket structure 322 may take the form of a rigid box sized and dimensioned to receive the example battery block 20 fabricated as described above. In this form, adhesive or the like may be used to bond the first example battery block 20 to the jacket structure 322. Alternatively, the jacket structure 322 may be formed by a mold structure such as the mold structure 126 used to form the first example battery block 20 as described above. In this case, the mold structure 126 may be textured or otherwise embossed to facilitate mechanical engagement of the matrix 36 to the mold structure 126. The example jacket structure 322 may be made of metal or other material that enhances the strength of the matrix to inhibit use of the second example battery block 320 at voltages other than the block voltage. The jacket structure 322 may further be configured to define tabs, projections, or a cover that covers at least the portion of the matrix 36 above the intermediate connectors 44 and 46 to inhibit unauthorized use of the second example battery block 320.

FIG. 23 illustrates a third example battery block 420 constructed in accordance with, and embodying, the principles of the present invention. The third example battery block 420 is formed by the combination of the first example battery block 20 as described above with a radio frequency identification (RFID) system 422. The RFID system 422 is embedded in the matrix 36 to allow easy identification and possibly tracking of the third example battery block 420. The RFID system 422 cannot be removed without destroying the matrix and/or the batteries forming the battery block 420 but allows data to be retrieved wirelessly. Physical access to the RFID system 422 is not necessary to identify and/or possibly track the battery block 420 during normal use thereof. The RFID system 422 may form one or more of spacers, such as the example spacers 122 defined above, that may be used to during the process of forming the third example battery block 420. cm What is claimed is:

1. A battery block comprising:
at least first and second batteries each defining at least one vent port;
a first terminal assembly connected to a positive terminal of the first battery;
a second terminal assembly connected to a positive terminal of the second battery;
at least one connector assembly arranged to electrically connect a negative terminal of the first battery to a positive terminal of the second battery;
a matrix of rigid material, where the matrix of rigid material
surrounds at least a portion of the first and second batteries to secure the first and second batteries together,
covers the at least one connector assembly to inhibit removal of the at least one connector assembly from the negative terminal of the first battery and the positive terminal of the second battery, and
defines a void over at least a portion of the at least one vent port in the first and second batteries.

2. A battery block as recited in claim 1, in which at least a portion of the first and second terminal assemblies is not covered by the matrix.

3. A battery block as recited in claim 1, further comprising an intermediate battery defining at least one vent port, in which:
a first connector assembly is connected to the negative terminal of the first battery and a positive terminal of the intermediate battery; and
a second connector assembly is connected to the negative terminal of the intermediate battery and the positive terminal of the second battery.

4. A battery block as recited in claim 3, in which at least a portion of the first and second terminal assemblies is not covered by the matrix.

5. A battery block as recited in claim 1, further comprising an identification system embedded within the matrix.

6. A battery system comprising:
a plurality of battery blocks each comprising
at least first and second batteries each defining at least one vent port,
a first terminal assembly connected to a positive terminal of the first battery,
a second terminal assembly connected to a positive terminal of the second battery,
at least one connector assembly arranged to electrically connect a negative terminal of the first battery to a positive terminal of the second battery,
a matrix of rigid material, where the matrix of rigid material
surrounds at least a portion of the first and second batteries to secure the first and second batteries together,
covers the at least one connector assembly to inhibit removal of the at least one connector assembly from the negative terminal of the first battery and the positive terminal of the second battery, and
defines a void over at least a portion of the at least one vent port in the first and second batteries; and
at least a portion of the first and second terminal assemblies of each of the plurality of battery blocks is not covered by the matrix to allow the plurality of battery blocks to be electrically connected.

7. A battery system as recited in claim 6, in which each battery block further comprises an intermediate battery defining at least one vent port, the battery system further comprising
a first connector assembly is connected to the negative terminal of the first battery and a positive terminal of the intermediate battery; and
a second connector assembly is connected to the negative terminal of the intermediate battery and the positive terminal of the second battery.

8. A battery system as recited in claim 6, further comprising an identification system embedded within the matrix.

9. A method of forming a battery block comprising the steps of:
providing at least first and second batteries each defining at least one vent port;
operatively connecting a first terminal assembly to a positive terminal of the first battery;
operatively connecting a second terminal assembly to a positive terminal of the second battery;
arranging at least one connector assembly to electrically connect a negative terminal of the first battery to a positive terminal of the second battery;
forming a matrix of rigid material by arranging block material such that the block material
surrounds at least a portion of the first and second batteries,
covers the at least one connector assembly, and
defines a void over at least a portion of the at least one vent port in the first and second batteries; and
allowing the block material to solidify to form the matrix of rigid material such that
the first and second batteries are secured together, and
removal of the at least one connector assembly from the negative terminal of the first battery and the positive terminal of the second battery is inhibited.

10. A method as recited in claim 9, in which the step of forming the matrix of rigid material comprises the step of not covering at least a portion of the first and second terminal assemblies.

11. A method as recited in claim 9, further comprising the steps of:
providing an intermediate battery defining at least one vent port;
connecting a first connector assembly to the negative terminal of the first battery and a positive terminal of the intermediate battery; and
connecting a second connector assembly to the negative terminal of the intermediate battery and the positive terminal of the second battery.

12. A method as recited in claim 11, in which the step of forming the matrix of rigid material comprises the step of not covering at least a portion of the first and second terminal assemblies.

13. A method as recited in claim 9, further comprising the step of embedding an identification system within the block material.

14. A method as recited in claim 9, in which the step of forming the matrix of rigid material comprises the steps of
arranging a strip of material to cover the at least vent port in the first and second batteries; and
removing the strip of material before the block material forms the matrix of rigid material.

15. A method as recited in claim 14, in which:
the step of arranging the strip of material comprises the step of providing at least one cord portion; and
the step of removing the strip of material comprises the step of removing the at least one cord portion before the block material forms the matrix of rigid material.

16. A method as recited in claim 14, in which:
the step of arranging the strip of material comprises the step of providing first and second cord portions; and
the step of removing the strip of material comprises the step of removing the first and second cord portions before the block material forms the matrix of rigid material.
